(19) United States
(12) Patent Application Publication
(10) Pub. No.: US 2005/0280929 A1
(43) Pub. Date: Dec. 22, 2005

(54) Deck plate and magnetic recording/playing apparatus having the same

(75) Inventors: Jae-Hoon Sim, Suwon-si (KR); Jae-Kab Seo, Suwon-si (KR); Myoung-Joon Kim, Suwon-si (KR); Jun-Young Kim, Suwon-si (KR); Bong-Joo Kim, Suwon-si (KR); Hyeong-Seok Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/109,657

(22) Filed: Apr. 20, 2005

(30) Foreign Application Priority Data
Jun. 18, 2004 (KR) 2004-45418

(51) Int. Cl. G11B 5/027

(52) U.S. Cl. 360/85

(57) ABSTRACT

A deck plate integrally forming the drum base and the guide rail, and a magnetic recording/playing apparatus having the same are disclosed. The deck plate has a chassis integrally forming a drum base for slopingly supporting a head drum assembly in a predetermined angle together with a guide rail for guiding at least one pole base assembly.

### CROSS-REFERENCE TO RELATED APPLICATIONS

This application claims the benefit under 35 U.S.C. §119(a) of Korean Patent Application No. 2004-45418 filed on Jun. 18, 2004, in the Korean Intellectual Property Office, the entire disclosure of which is incorporated herein by reference.

### BACKGROUND OF THE INVENTION

1. Field of the Invention

The present invention relates to a magnetic recording/playing apparatus, such as a video tape recorder (VTR), a camcorder and the like. More particularly, the present invention relates to a deck plate on which a head drum and a pole base are mounted, and a magnetic recording/playing apparatus having the deck plate.

2. Description of the Related Art

Generally, a magnetic recording/reproducing apparatus such as a video tape recorder and a camcorder includes a deck mechanism for recording/reproducing voice and video information to and from a magnetic tape by playing a magnetic tape along a predetermined running path.

The deck mechanism performs basic functions of recording/playing (REC/PLAY) and fast forward/rewind (FF/REW) and also performs functions, such as playing a still image and a slow video, high speed search and reverse playing, which are selectively added depending on the type of products by changing status of each unit of the deck mechanism through a predetermined program.

FIG. 1 illustrates a conventional deck mechanism 1 applied to a camcorder. The deck mechanism 1 comprises a main chassis 10, a sub-chassis 20 arranged to move with respect to the main chassis 10, a head drum assembly 2, and a first and a second pole base assemblies 16 and 17 having a plurality of rollers and poles, for moving so that a magnetic tape may be arranged at a predetermined position in the inside of the main chassis 10 upon loading and unloading the magnetic tape.

The head drum assembly 2 comprises a head drum 11 having a magnetic head for recording/playing information by scanning a magnetic tape, a drum base 12 for fixing the head drum 11 to have a predetermined slope with respect to the main chassis 10.

The first and the second pole base assemblies 16 and 17 comprise a first and a second pole bases 16a and 17a for moving in a sliding manner along a first and a second guide grooves 14 and 15 of a guide rail 13 installed in the main chassis 10 upon loading/unloading a magnetic tape, a first and a second slant poles 16b and 17b slopingly projected on the first and the second pole bases 16a and 17a, and a first and a second guide rollers 16c and 17c for controlling up and down movement of a magnetic tape entering the first and the second slant poles 16b and 17b.

As shown in FIGS. 1 and 2B, the guide rail 13 is projected to a predetermined height upward from the main chassis 10 to guide and support the first and the second pole bases 16a and 17a.

However, according to the conventional deck mechanism 1, the drum base 12 for installing the head drum 11 on the main chassis 10 is manufactured as a separate part and assembled to the main chassis 10 using a screw 19, and the guild rail 13 for guiding the first and the second pole bases 16a and 17a upon loading/unloading a magnetic tape is manufactured as a separate part and assembled to the main chassis 10 and the drum base 12 using screws 20 and 21 as shown in FIGS. 2A, 2B, and 3.

Therefore, according to the conventional deck mechanism 1, since the drum base 12 and the guide rail 13 must be elaborately manufactured using separate molds so that they may be assembled; therefore, manufacturing costs increase. Further, since the assembly should be performed using screws for fastening, the assembling process is complicated and productivity is reduced.

Also, according to the conventional deck mechanism 1, since the guide rail 13 is projected to a predetermined height upward from the main chassis 10 so as to guide and support the first and the second pole bases 16a and 17a, there is the possibility that the guide rail 13 interferes with the inside or other parts of a tape cassette, and thereby the deck mechanism 1 operates in an unstable manner upon loading/unloading a magnetic tape.

### SUMMARY OF THE INVENTION

An aspect of the present invention is to solve at least the above problems and/or disadvantages and to provide at least the advantages described below. Accordingly, an aspect of the present invention is to provide a deck plate and a magnetic recording/playing apparatus having the same that can reduce the number of parts with a simple construction and operate in a stable manner.

In order to achieve the above-described aspects of the present invention, there is provided a deck plate of a magnetic recording/playing apparatus comprising a chassis mounting a drum base for supporting a head drum assembly and a guide rail for guiding at least one pole base assembly, the deck plate is configured in such a way that the guide rail guides an entire moving path of the pole base assemblies and the chassis integrally forms the drum base and the guide rail.

Preferably, the drum base is integrally formed with the chassis and bent upward a predetermined angle from the chassis.

The guide rail comprises a guide groove formed at the same height as the plane of the chassis.

The pole base assembly comprises a guide roller for controlling up and down movement of a magnetic tape, and a pole base for mounting the guide roller and having a guide boss of which central axis is separated by a predetermined distance toward the head drum assembly from a central axis of the guide roller, for being guided along the guide groove.

At this point, a predetermined separated distance of the guide boss from the central axis of the guide roller may be about 1.2 mm.

In another aspect of the present invention, there is provided a magnetic recording/playing apparatus, which comprises a deck plate having a drum base for supporting a head drum assembly, a guide rail for guiding an entire moving path of at least one pole base assembly, and a chassis mounting the drum base and the guide rail, wherein the chassis integrally forms the drum base and the guide rail.

Preferably, the drum base is integrally formed with the chassis and bent upward a predetermined angle from the chassis.

The guide rail comprises a guide groove formed at the same height as the plane of the chassis.

The pole base assembly comprises a guide roller for controlling up and down movement of a magnetic tape, and a pole base for mounting the guide roller and having a guide boss of which central axis is separated a predetermined distance toward the head drum assembly from a central axis of the guide roller, for being guided along the guide groove. At this point, a predetermined separated distance of the guide boss from the central axis of the guide roller may be about 1.2 mm.

### BRIEF DESCRIPTION OF THE DRAWINGS

The above aspects and features of the present invention will be more apparent by describing certain embodiments of the present invention with reference to the accompanying drawings, in which:

FIG. 1 is a schematic plan view of a deck mechanism of the conventional camcorder;

FIGS. 2A and 2B are a plan view and a side elevation view, respectively, illustrating a main chassis of the deck mechanism mounting a drum base and a guide rail shown in FIG. 1;

FIG. 3 is a plan view of the drum base and the guide rail shown in FIG. 2A;

FIGS. 4 and 5 are schematic plan views of a deck mechanism of a camcorder adopting a deck plate according to embodiments of the present invention;

FIG. 6 is a plan view of a deck plate shown in FIGS. 4 and 5;

FIG. 7 is a partial, cross-sectional view of a drum base of the deck plate shown in FIGS. 4 and 5 illustrating a status where a head drum is mounted;

FIG. 8 is a partial, plan view of a first pole base assembly of a tape running guide unit of the deck mechanism shown in FIGS. 4 and 5; and

FIG. 9 is a side, cross-sectional view of a first pole base assembly of a tape running guide unit of the deck mechanism shown in FIGS. 4 and 5.

Throughout the drawings, it should be understood that like reference numbers refer to like features, structures, and elements.

### DETAILED DESCRIPTION OF EXEMPLARY EMBODIMENTS

Certain embodiments of the present invention will be described in greater detail with reference to the accompanying drawings.

The matters defined in the description such as a detailed construction and elements are provided to assist in a comprehensive understanding of the invention. Thus, descriptions of well-known functions or constructions are omitted for the sake of clarity and conciseness.

A camcorder, which is a magnetic recording/playing apparatus adopting a deck plate according to an embodiment of the present invention, includes a deck mechanism for playing/recording a voice and video information to and from a magnetic tape by playing a magnetic tape along a predetermined running path.

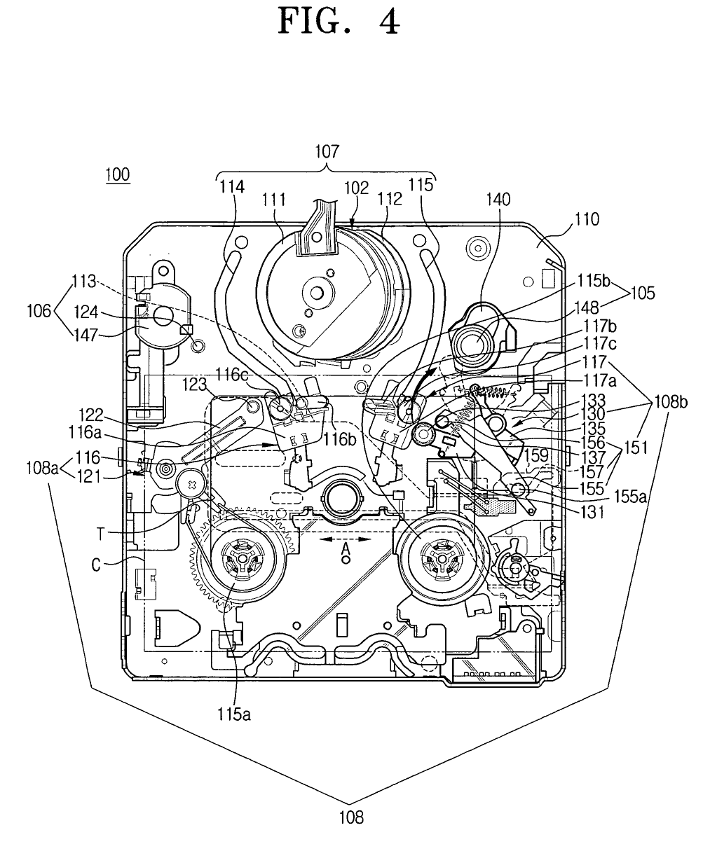

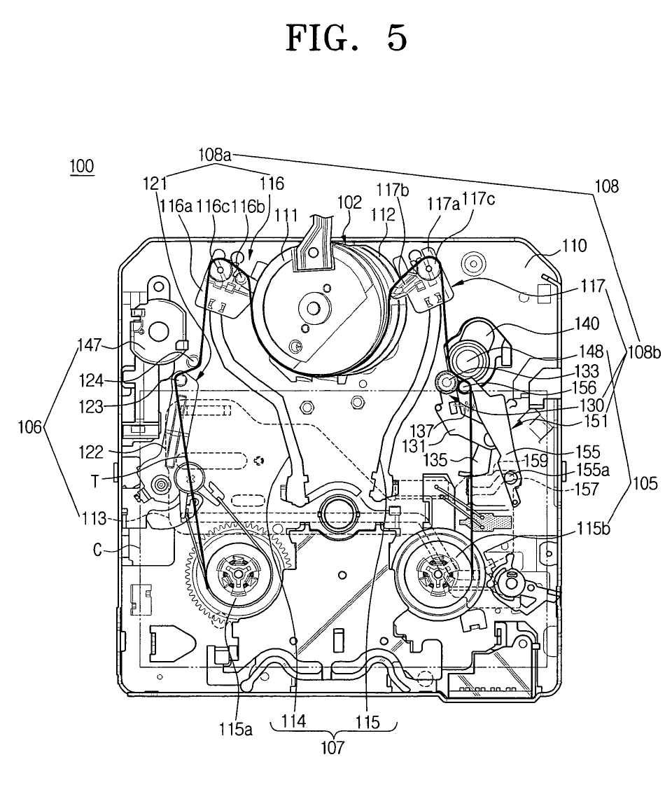

FIGS. 4 and 5 illustrate a deck mechanism 100 of a camcorder adopting a deck plate according to an embodiment of the present invention.

The deck mechanism 100 comprises a deck plate 110, a running operation unit 105 for running a magnetic tape T, a tape running guide unit 108 for guiding a magnetic tape T running on the deck plate 110 by operation of the running operation unit 105, and a loading operation unit 106 for moving each element of the tape running guide unit 108 upon loading/unloading a magnetic tape T. The deck plate 110 comprises a single chassis. The chassis 110 mounts a head drum assembly 102 at its upper central portion in FIG. 4.

The head drum assembly 102 comprises a head drum 111 having a magnetic head for recording/playing information by scanning a magnetic tape, and a drum base 112 for fixing and installing the head drum 111 using screws 119 (FIG. 7) so that the head drum 111 may form a predetermined slope with respect to the chassis 110.

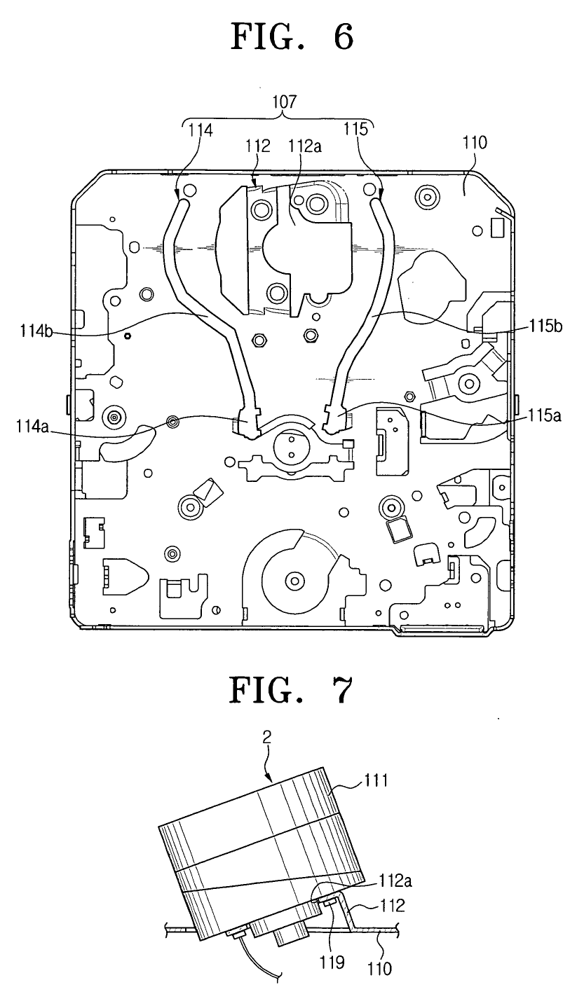

As shown in FIGS. 6 and 7, the drum base 112 has a slant fixing surface 112a that is formed integrally with the chassis 110 and bent a predetermined angle.

The slant fixing surface 112a is formed in such a way that a part of the chassis 110 is preferably cut by a press process and projected upward from the main chassis 110.

The running operation unit 105 comprises a capstan shaft 148 rotated by a capstan motor 140, reel tables 115a and 115b on a supplying and a winding sides, operated by the capstan motor 140, for receiving a tape reel of a cassette tape C. The capstan motor 140 supplies power for operating the reel tables 115a and 115b on the supplying and the winding sides via a power transferring gear train (not shown). Since the power transferring gear train is well known in the art, a detail description thereof will be omitted.

The loading operation unit 106 comprises a loading motor 147 installed in the chassis 110, and a main slide member 113 installed in the chassis 110 so as to slide in a reciprocating manner in an arrow direction A using a slide member operation unit (not shown) operated by receiving power from the loading motor 147. Since the slide member operation unit is well known in the art, a detail description thereof will be omitted.

The main slide member 113 has a guide protuberance 159 and a guide groove 157 respectively, functioning in cooperation with a lower end of a pressing lever 135 of a pinch roller assembly 130 of a tape running guide unit 108 and a joining protuberance 155a of a review arm 155 of a review pole assembly 151, which will be described below, upon loading/unloading a magnetic tape T.

The tape running guide unit 108 comprises tape guide units 108a and 108b on a supplying and a winding reel sides, having a plurality of rollers and fixed pole members for moving so that a magnetic tape T is arranged in a predetermined position of the inside of the chassis 110 upon loading/unloading a magnetic tape T.

The tape guide unit 108a on the supplying reel side has a tension pole assembly 121 and a first pole base assembly 116.

The tension pole assembly 121 comprises a tension arm 122 pivotably installed in the chassis 110, a first tension pole 123 projected straight at a front end of the tension arm 122, and a fixed pole or an impedance roller 124 fixed in the chassis 110.

The tension arm 122 is rotated to a position as shown in FIG. 4 or FIG. 5 by a tension arm operation unit (not shown) which receives power from the loading motor 147 upon loading/unloading a magnetic tape T. Since the tension arm operation unit is well known in the art, a detailed description thereof will be omitted.

The tension pole 123 exerts a predetermined tension on a magnetic tape T by pulling the magnetic tape T to the left of the chassis 110 and the impedance roller 124 controls up and down movement of the magnetic tape T running via the tension pole 123.

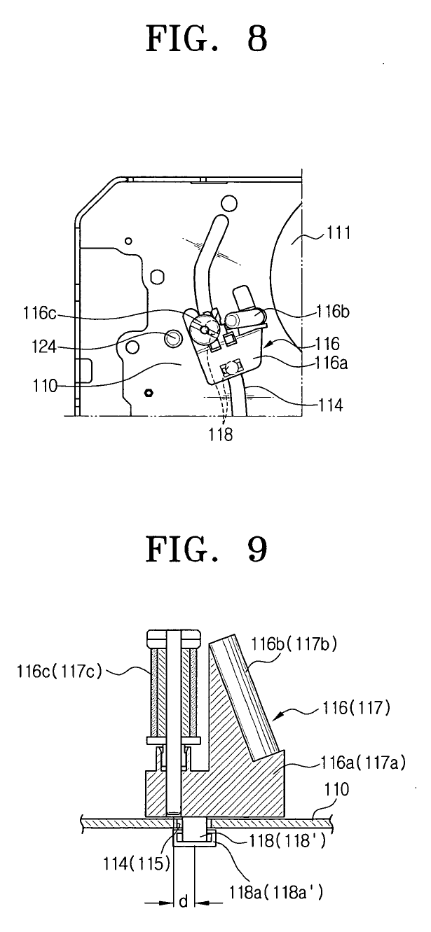

As shown in FIGS. 8 and 9, a first pole base assembly 116 comprises a first pole base 116a for moving in a sliding manner along a first guide groove 114 of a guide rail 107, which will be described below with respect to a known pole base operation unit (not shown) operated by receiving power from the loading motor 147 upon loading/unloading a magnetic tape T, a first slant pole 116b slopingly projected on the first pole base 116a, and a first guide roller 116c for controlling up and down movement of a magnetic tape T entering the first slant pole 116b.

As shown in FIGS. 8 and 9, the first pole base 116c has two first guide bosses 118 at its lower part.

The first guide bosses 118 are guided by being inserted into the first guide groove 114 of the guide rail 107 and has a first supporting end 118a of which width is widened greater than a width of the first guide groove 114 to prevent the first guide bosses 118 from separating from the first guide groove 114.

Further, the first guide bosses 118 are arranged in such a way that its central axis is separated a predetermined distance d toward the head drum assembly 102 from a central axis of the first guide roller 116c. At this point, a predetermined separated distance d of the first guide boss 118 from the central axis of the first guide roller 116c may be about 1.2 mm.

The reason why the first guide bosses 118 are formed in a lower part of the first pole base 116a in such a way that its central axis is separated as much as about 1.2 mm from the central axis of the first guide roller 116c, is for supporting the first pole base 116a at a center of gravity between the first slant pole 116b and the first guide roller 116c and for the first pole base 116c, so as to prevent interference due to contact with the impedance roller 124 and the head drum 111 when the first pole base 116c moves between the impedance roller 124 and the head drum 111 of the head drum assembly 102 upon loading/unloading a magnetic tape T as shown in FIG. 8.

Referring back to FIG. 4, the tape guide unit 108b on the winding reel side comprises a review pole assembly 151, a second pole base assembly 117, and a pinch roller assembly 130.

The review pole assembly 151 comprises a review arm 155 pivotably installed in the chassis 110, and a review pole 156 projected straight at a front end of the review arm 155.

The review arm 155 has a joining protuberance 155a joined to a guide groove 157 of the main slide member 113 so as to function in cooperation with the main slide member 113 upon loading/unloading a magnetic tape T, and preferably gives a predetermined tension to the magnetic tape T by pulling the magnetic tape T to the right of the chassis 110.

The second pole base assembly 117 has the same construction as the first pole base assembly 116 except that it is preferably symmetrically arranged with respect to the first pole base assembly 116.

Namely, as shown in the drawings, the second pole base assembly 117 comprises a second pole base 117a for moving in a sliding manner along a second guide groove 115 of a guide rail 107 which will be described below upon loading/unloading a magnetic tape T, a second slant pole 117b slopingly projected on the second pole base 117a, and a second guide roller 117c for controlling the up and down movement of a magnetic tape T entering the second slant pole 117b.

Like the first pole base 116a of the first pole base assembly 116, the second pole base 117a has a second guide boss 118′ projected to the lower part so that its central axis is separated a predetermined distance d, which can be about 1.2 mm toward the head drum assembly 102 from a central axis of a second guide roller 117c.

The second guide boss 118′, as shown in FIG. 9, is guided by being inserted into the second guide groove 115 of the guide rail 107 and has a second support end 118a′ extended greater than a width of the second guide groove 115 to prevent the second guide boss 118′ from separating from the second guide groove 115.

The pinch roller assembly 130 comprises a pinch roller arm 131 pivotably installed in the chassis 110, a pinch roller 133 rotatably installed at an end of the pinch roller arm 131, a pressing lever 135 for rotating on a rotational axis of the pinch roller arm 131, and a tension spring 137 for connecting the pressing lever 135 with the pinch roller arm 131.

As shown in FIG. 6, the guide rail 107 comprises a first and a second guide grooves 114 and 115 formed on the chassis 110, corresponding to a first and a second guide bosses 118 and 118′ so as to guide an entire moving path of the pole base assemblies 116 and 117 by receiving the first and the second guide bosses 118 and 118′ of the first and the second pole base assemblies 116 and 117, respectively.

The first and the second guide grooves 114 and 115 comprises extension holes 114a and 115a for assembling, of which size is bigger than a size of the first and the second supporting ends 118a and 118a′ so as to receive the first and the second supporting ends 118a and 118a′ of the first and the second guide bosses 118 and 118′ upon assembling, and guide rail parts 114b and 115b for guiding the first and the second guide bosses 118 and 118′ upon loading/unloading a magnetic tape T, respectively.

The first and the second guide grooves 114 and 115 are preferably integrally formed with the chassis 110 in a symmetric form, preferably by a press process.

The heights of the first and the second guide grooves 114 and 115, such as the height of a chassis plane 110 where the first and the second guide grooves 114 and 115 are formed, are set in such a way that the first and the second guide rollers 116c and 117c may control the up and down movement of a magnetic tape T when the first and the second pole bases 116a and 117a are installed in the first and the second guide grooves 114 and 115.

As described above, since the chassis 110 of the deck plate according to an embodiment of the present invention integrally forms the drum base 112 and the guide rail 107, which reduces the number of manufacturing molds, the number of assembly process steps and manufacturing costs, while increasing productivity. Further, since the first and the second pole bases 116a and 117a are supported and moved at a center of gravity without interfering with the impedance roller 124 and the head drum 111 upon loading/unloading a magnetic tape T and the guide rail 107 comprises the grooves 114 nd 115 formed at the same height as the chassis plane so as not to generate interference with the other parts and the inside of the cassette upon loading/unloading a magnetic tape T, a mechanically stable operation is performed.

Tape loading and unloading operations of the deck mechanism 100 of the camcorder adopting the deck plate according to an embodiment of the present invention having the foregoing construction will now be described in more detail with reference to FIGS. 4 through 8 in the following.

First, the loading operation will be described. The tape cassette C is moved down in the reel tables 115a and 115b on the supplying and the winding sides of the chassis 110 as represented by a dotted line of FIG. 4, and then when the loading motor 147 is operated, the tension arm 122 is rotated counterclockwise by the tension arm operation unit. Accordingly, the tension pole 123 pushes a magnetic tape T toward the impedance roller 124 as shown in FIG. 5.

Further, the first and the second pole bases 116a and 117a of the first and the second pole base assemblies 116 and 117 is moved toward the head drum 111 by the pole base operation unit operated by receiving power from the loading motor 147. Accordingly, the first and the second guide bosses 118 and 118′ (shown in FIG. 9) slides on along the first and the second guide grooves 114 and 115 of the guide rail 107, and the first and the second guide rollers 116c and 117c draw out the magnetic tape T and position the magnetic tape T against to the head drum 111.

At this point, since the first and the second guide bosses 118 and 118′ are separated as much as about 1.2 mm toward the head drum assembly 102 from the central axes of the first and the second guide rollers 116c and 117c, the first and the second pole base assemblies 116 and 117 can not only move without contact with the impedance roller 124 and the head drum 111 but also move in a stable manner along a center of gravity.

The main slide member 113 is operated by the slide member operation unit to preferably move in the direction of arrow A, which is to the left. Accordingly, the guide protuberance 159 of the main slide member 113 pushes out a lower end of the pressing lever 135 to the left. Resultantly, the tension spring 137 is extended while the pressing lever 135 is rotated clockwise. Due to the tension of the tension spring 137, the pinch roller 133 is stuck against the capstan shaft 148.

The review arm 155 is also rotated clockwise by the guide groove 157 of the main slide member 113 and, accordingly, the review pole 156 pulls the magnetic tape T to the right of the chassis 110 so as to give a predetermined tension to the magnetic tape T.

With a magnetic tape T loaded on the position shown in FIG. 5 in this manner, the capstan motor 140 performs the functions of REC/PLAY and FF/REW for winding and releasing in high speed a magnetic tape T on and from the tape reel of the cassette C by operating the reel tables 115a and 115b on the supplying and the winding sides using the power transfer gear train.

The deck mechanism 100 operates in a reverse order upon unloading a magnetic tape T. Accordingly, the tension pole 123, the first and the second guide rollers 116c and 117c, the pinch roller 133, and the review pole 156 are restored back to the position shown in FIG. 4.

As described above, according to the deck plate of an embodiment of the present invention and the magnetic recording/playing apparatus having the same, the drum base and the guide rail need not be elaborately manufactured using separate molds because the drum base and the guide rail can be formed integrally with the chassis, and thus, reducing manufacturing costs.

Though the deck mechanism 100 having the deck plate according to an embodiment of the present invention has been explained using a camcorder as an example, the present invention is not limited to that specific case, but may be applied to a magnetic recording/playing apparatus having a deck mechanism such as a video tape recorder and a digital audio tape recorder.

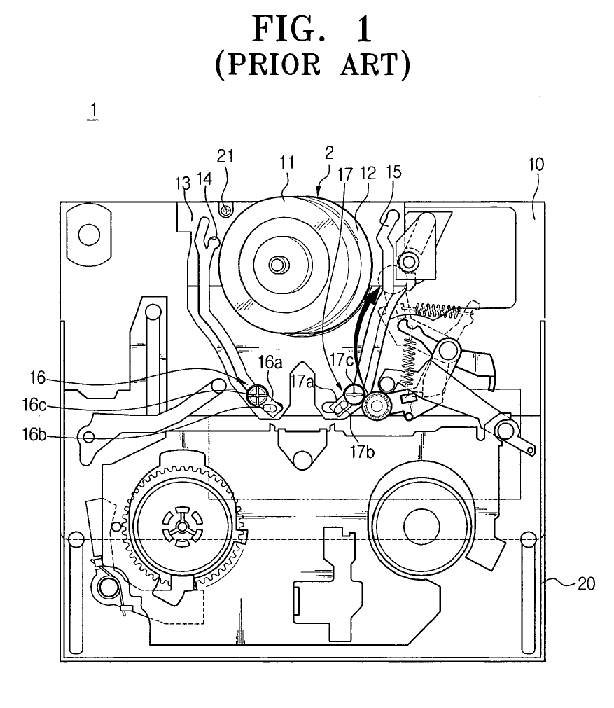

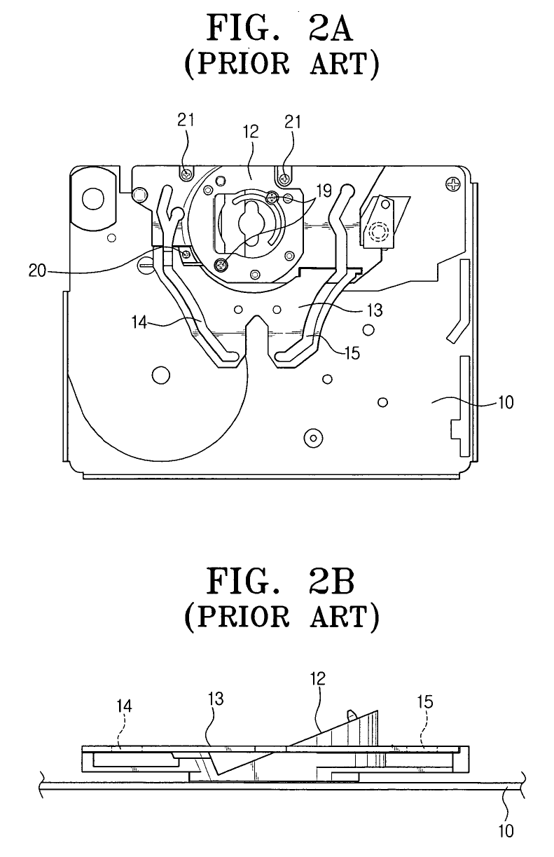

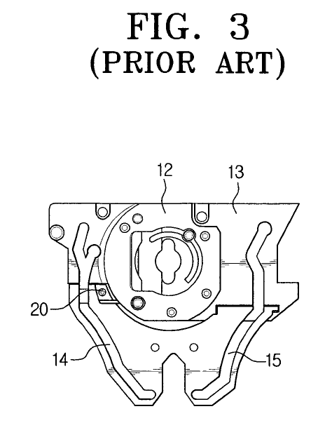

Although only an embodiment of the deck mechanism 100 having the deck plate, wherein the deck plate comprises a single chassis, according to the present invention has been described and illustrated, however, the deck mechanism 1 comprising the main chassis and the sub chassis, as shown in FIG. 1, is also applicable.

Further, according to the deck plate and the magnetic recording/playing apparatus having the same according to an embodiment of the present invention, a process for assembling the drum base and the guide rail using screws is not required because the drum base and the guide rail can be formed integrally with the chassis, and thus, the assembly process is simplified and productivity is increased.

Furthermore, according to the deck plate and the magnetic recording/playing apparatus having the same according to an embodiment of the present invention, the pole bases are supported and moved at the center of gravity without interfering with the impedance roller and the head drum upon loading/unloading a magnetic tape because the guide bosses of the pole bases are separated a predetermined distance toward the head drum from the central axes of the guide roller. In the meantime, since the guide rail comprises the groove formed at the same height as the chassis plane and the guide rail does not interfere with other parts or the inside of the cassette upon loading/unloading a magnetic tape, mechanically stable operation can be achieved.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A deck plate of a magnetic recording/playing apparatus having a chassis which mounts a drum base for supporting a head drum assembly and a guide rail for guiding at least one pole base assembly,
wherein the guide rail guides an entire moving path of the pole base assemblies, and
the chassis integrally forms the drum base and the guide rail.

2. The deck plate of claim 1, wherein the drum base is formed integrally with the chassis and bent upward by a predetermined angle from the chassis.

3. The deck plate of claim 1, wherein the guide rail comprises a guide groove formed at the same height as a plane of the chassis.

4. The deck plate of claim 3, wherein the pole base assembly comprises:
a guide roller for controlling up and down movement of a magnetic tape; and
a pole base mounting the guide roller, having a guide boss of which central axis is separated a predetermined distance toward the head drum assembly from a central axis of the guide roller, for being guided along the guide groove.

5. The deck plate of claim 4, wherein the predetermined separated distance of the guide boss from the central axis of the guide roller is about 1.2 mm.

6. A magnetic recording/playing apparatus comprising:
a deck plate having a drum base for supporting a head drum assembly, a guide rail for guiding an entire moving path of at least one pole base assembly, and a chassis mounting the drum base and the guide rail,
wherein the chassis integrally forms the drum base and the guide rail.

7. The magnetic recording/playing apparatus of claim 6, wherein the drum base is formed integrally with the chassis and bent upward a predetermined angle from the chassis.

8. The magnetic recording/playing apparatus of claim 6, wherein the guide rail comprises a guide groove formed at the same height as a plane of the chassis.

9. The magnetic recording/playing apparatus of claim 8, wherein the pole base assembly comprises:
a guide roller for controlling up and down movement of a magnetic tape; and
a pole base for mounting the guide roller and having a guide boss of which central axis is separated a predetermined distance toward the head drum assembly from a central axis of the guide roller, for being guided along the guide groove.

10. The magnetic recording/playing apparatus of claim 9, wherein a predetermined separated distance of the guide boss from the central axis of the guide roller is about 1.2 mm.
